(19) United States
(12) Patent Application Publication
(10) Pub. No.: US 2017/0209833 A1
(43) Pub. Date: Jul. 27, 2017

(54) HOLLOW FIBER MEMBRANE FILTER WITH VALVE OPERATED REVERSE FLOW FOR MANUAL BACKFLUSH

(71) Applicant: Andrew Michael Pierce, Redding, CA (US)

(72) Inventor: Andrew Michael Pierce, Redding, CA (US)

(21) Appl. No.: 15/406,381

(22) Filed: Jan. 13, 2017

Related U.S. Application Data
(60) Provisional application No. 62/281,469, filed on Jan. 21, 2016.

(51) Int. Cl. B01D 65/02; C02F 1/44; B01D 63/04

(52) U.S. Cl. CPC B01D 65/02; B01D 63/04; C02F 1/44; B01D 2313/44; B01D 2313/18; B01D 2313/105; B01D 2313/48; B01D 2317/04; B01D 2321/04; C02F 2201/006; C02F 2201/005; C02F 2303/16; C02F 2307/06

(57) ABSTRACT

A water filtering system incorporates a plurality of membrane filters installed in succession along two parallel manifolds. Each manifold is separately controllable such that the manifolds are able to be separately backflushed. The two parallel manifolds share a source water inlet and a clean water outlet. In some embodiments, the membrane filters are able to clean contaminated water to 99.999% 5 log of Bacteria, Protozoa and Cysts.

### RELATED APPLICATIONS

This Patent Application claims priority under 35 U.S.C. 119(e) of the co-pending U.S. provisional patent application, Application No. 62/281,469, filed on Jan. 21, 2016, and entitled “HOLLOW FIBER MEMBRANE FILTER WITH VALVE OPERATED REVERSE FLOW FOR MANUAL BACKFLUSH,” which is hereby incorporated in its entirety by reference.

### FIELD OF THE INVENTION

The present invention relates to water filtering devices. More particularly, the present invention relates to an easily workable and repairable water filtering device.

### BACKGROUND OF THE INVENTION

Access to clean water is a growing health crisis throughout the global population. Particularly, clean water is required for drinking, cooking and bathing. Additionally, clean water is one aspect of improving sustainable food production in order to reduce poverty and hunger. Ensuring access to clean water and especially clean drinking water can provide many benefits to diverse populations and groups.

### SUMMARY OF THE INVENTION

A water filtering system incorporates a plurality of membrane filters installed in succession along two parallel manifolds. Each manifold is separately controllable such that the manifolds are able to be separately backflushed. The two parallel manifolds share a source water inlet and a clean water outlet. In some embodiments, the membrane filters are able to clean contaminated water to 99.999% 5 log of Bacteria, Protozoa and Cysts.

In a first aspect, a water filter comprises a water inlet configured to couple with a water source outlet, a first filter cartridge coupled to the water source outlet, a second filter cartridge configured parallel to the first filter cartridge and coupled to the water source outlet, and a clean water outlet coupled to the first filter cartridge and the second filter cartridge and configured to output clean water. In some embodiments, the water filter comprises a backflush drain coupled to the first filter cartridge and the second filter cartridge. In some embodiments, the first filter cartridge and the second filter cartridge are separately backflushed. In some embodiments, the water filter comprises a first ball valve coupled to the first filter cartridge and a second ball valve coupled to the second filter cartridge. In some of these embodiments, the first ball valve controls the water flow through the first filter cartridge and the second ball valve controls water flow through the second filter cartridge. In some embodiments, the first filter and the second filter comprise hollow fiber membrane filter cartridges. In some of these embodiments, the first filter and the second filter comprise 0.05 micron hollow fiber membrane filter cartridges. In some embodiments, the water source outlet comprises one of a faucet, a sink, and a hose. In some embodiments, the clean water outlet outputs drinking water.

In another aspect, a method of purifying water comprises coupling a water filter water source inlet with a contaminated water source outlet, wherein the water filter comprises a plurality of parallel manifolds, activating the water source outlet to pass water through one or more filter cartridges of the parallel manifolds, and outputting clean water from a clean water outlet of the water filter. In some embodiments, the one or more filter cartridges comprise hollow fiber membrane filter cartridges. In some of these embodiments, the one or more filter cartridges comprise 0.05 micron hollow fiber membrane filter cartridges. In some embodiments, the water source outlet comprises one of a faucet, a sink, and a hose. In some embodiments, the clean water outlet outputs drinking water. In some embodiments, the method comprises backflushing the water filter to clean the one or more filter cartridges. In some embodiments, the parallel manifolds are separately backflushed.

In a further aspect, a water filtering system comprises a water inlet configured to couple with a water source outlet, a first manifold comprising a plurality of filter cartridges, a second manifold parallel to the first manifold and comprising a plurality of filter cartridges, and a clean water outlet coupled to the first manifold and the second manifold and configured to output clean drinking water. In some embodiments, the first manifold and the second manifold each comprise three filter cartridges. In some embodiments, the first manifold is controlled by a first ball valve and the second manifold is controlled by a second ball valve. In some of these embodiments, the first ball valve and the second ball valve are turned to an operative position to allow water to pass through the first manifold and the second manifold. In further embodiments, the first ball valve and the second ball valve are turned to a reverse position to backflush the first manifold and the second manifold. In some embodiments, the first manifold and the second manifold are separately backflushed.

### BRIEF DESCRIPTION OF THE DRAWINGS

FIG. 1 illustrates a water filter in accordance with some embodiments.

FIG. 2 illustrates a method of purifying water.

### DETAILED DESCRIPTION OF THE INVENTION

In the following description, numerous details are set forth for purpose of explanation. However, one of ordinary skill in the art will realize that the invention may be practiced without the use of these specific details or with equivalent alternatives. Thus, the presently claimed invention is not intended to be limited to the embodiments shown but is to be accorded the widest scope consistent with the principles and features described herein.

Embodiments are directed to a filtering system which incorporates a plurality of membrane filters installed in succession along two parallel manifolds. Each manifold is separately controllable such that the manifolds are able to be separately backflushed. The two parallel manifolds share a source water inlet and a clean water outlet.

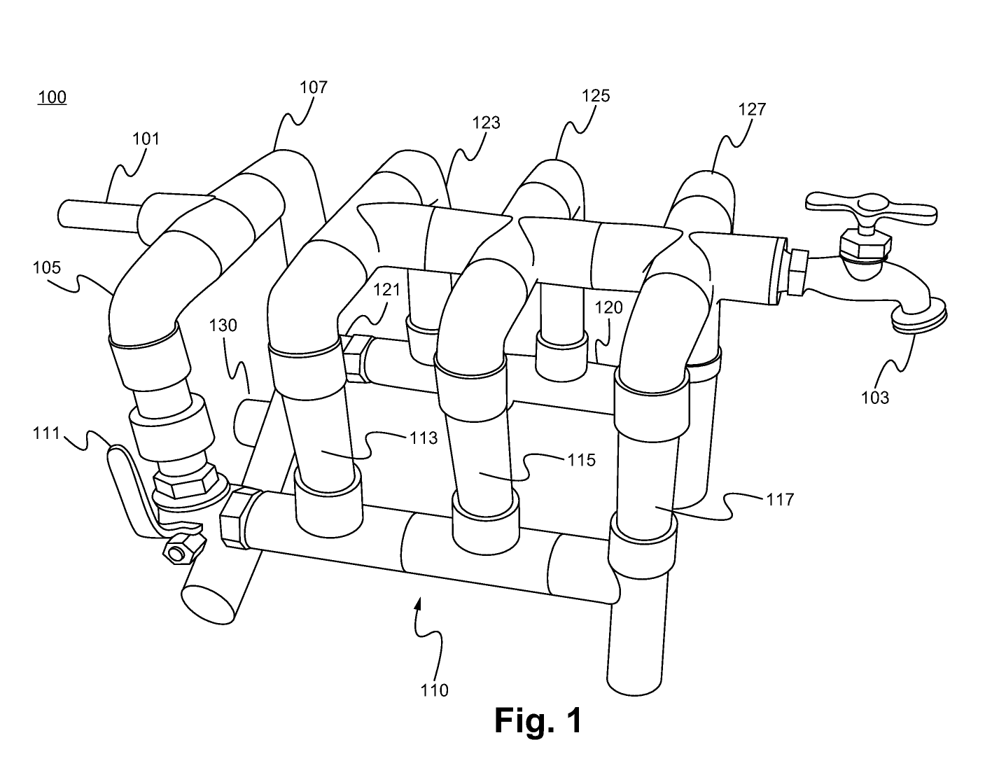

Referring now to FIG. 1, a water filter is depicted therein. The water filter 100 comprises a water source inlet 101 configured to couple with a water source outlet, a first manifold 110 and a second manifold 120 coupled to the water source inlet 101. In some embodiments, such as shown within FIG. 1, the first manifold 110 is parallel to the second manifold 120. The first manifold 110 comprises one or more filter cartridges 113, 115 and 117. Particularly, as shown within FIG. 1, the first manifold comprises three filter cartridges. However, the first manifold is able to comprise any appropriately number of desired filter cartridges. Additionally, as shown within FIG. 1, the second manifold 120 comprises one or more filter cartridges 123, 125 and 127. As shown within FIG. 1, the second manifold 120 comprises three filter cartridges. However, the second manifold 120 is able to comprise any appropriately number of desired filter cartridges. The first manifold 110 and the second manifold 120 feed into a single clean water outlet 103. In some embodiments, the first manifold 110 connects to the water source inlet 101 through a first arm 105 and the second manifold 120 connects to the water source inlet 101 through a second arm 107. Water from the source water inlet 101 travels through first manifold 110 and the second manifold 120 and out through the clean water outlet 103.

As shown within FIG. 1, the first manifold 110 comprises a first ball valve 111, which controls water flow through the first manifold 110 and the one or more filter cartridges and the second manifold 120 comprises a second ball valve 121, which controls water flow through the first manifold 120. The first ball valve 111 and the second ball valve 121 are turned to an operative position to allow water to pass through the first manifold 110 and the second manifold 120. Particularly, the first manifold 110 and the second manifold 120 are separately controlled with three way ball valve. When the one or more filters of the first manifold 110 begin to fowl or are clogged, the first ball valve 111 is able to be turned to a backflush position. This, in turn sends clean water from the second manifold 120 in a reverse flow and through the one or more filter cartridges of the first manifold 110 and out of the back flush drain 130. This process is then able to be reversed to clean the one or more filter cartridges of the second manifold 120. Once the one or more filters of the first manifold 110 and the one or more filters of the second manifold have been backflushed, the ball vales are able to be turned back to the operating position.

In some embodiments, the one or more filter cartridges of the first manifold 110 and the one or more filter cartridges of the second manifold 120 comprise hollow fiber membrane filter cartridges. However, the one or more filter cartridges of the first manifold 110 and the one or more filter cartridges of the second manifold 120 are able to comprise any appropriately desired filter cartridges. For example, in some embodiments, the one or more filter cartridges of the first manifold 110 and the one or more filter cartridges of the second manifold 120 comprise 0.05 micron hollow fiber membrane filter cartridges. Particularly, in some embodiments, with the first ball valve 110 and the second ball valve 120 are turned to an operative position such that contaminated water passes through the one or more filter cartridges of the first manifold and one or more filter cartridges of the second manifold, the contaminated water is able to be cleaned to 99.999% 5 log of Bacteria, Protozoa and Cysts. In this manner, the water filter 100 is able to output clean drinking water from a contaminated water source. In some embodiments, the water source inlet 101 is able to couple to one of a faucet, a sink, and a hose. However, the water source inlet 101 is able to couple to any appropriately desired contaminated water source.

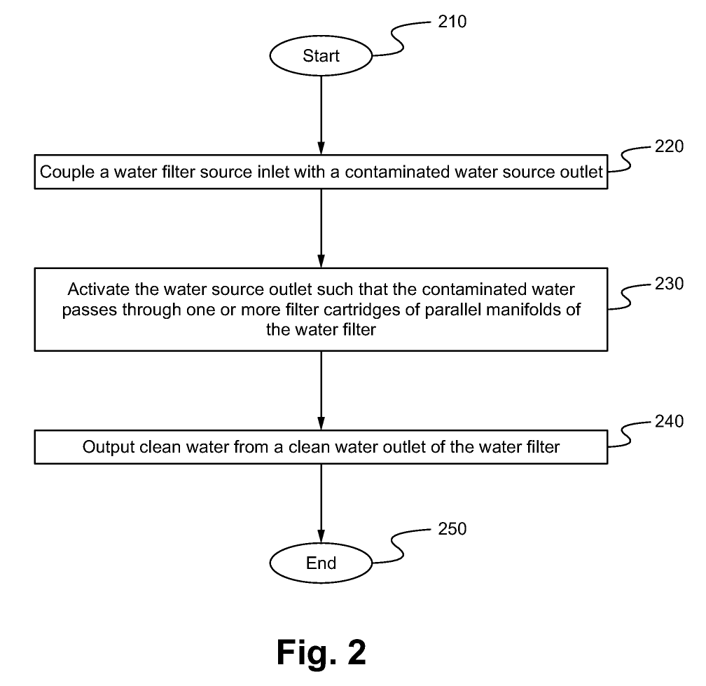

FIG. 2 illustrates a method of water in accordance with some embodiments. The method begins in the step 210. In the step 220, a water filter source inlet is coupled with a contaminated water source outlet. In some embodiments, the water filter comprises a plurality of parallel manifolds, such as the water filter 100 as described above. In the step 230, the water source outlet is activated to pass water through one or more filter cartridges of the parallel manifolds and in the step 240, clean water is outputted from a clean water outlet of the water filter. The method ends in the step 250.

In some embodiments, wherein the one or more filter cartridges comprise hollow fiber membrane filter cartridges. In some of these embodiments, the one or more filter cartridges comprise 0.05 micron hollow fiber membrane filter cartridges. However, as described above, the one or more filter cartridges are able to comprise any appropriately desired filter cartridges. The water source outlet is able to comprise one of a faucet, a sink, and a hose. However, the water source outlet is able to couple to any appropriately desired contaminated water source. The clean water outlet outputs drinking water. For example, in some embodiments, the contaminated water is able to be cleaned to 99.999% 5 log of Bacteria, Protozoa and Cysts. In some embodiments, the method comprises backflushing the water filter to clean the one or more filter cartridges when the one or more filter cartridges become dirty. As described above, the parallel manifolds are able to be separately backflushed.

In operation, the water filtration system such as described above, utilizes a plurality of individual filter cartridges installed on two parallel manifolds. Both of these manifolds are separately controlled through a three-way ball valve and feed into a singly outlet manifold. As described above, the water filter is able to be installed inline to a faucet or sink or can be operated by a hose bib or other shut off device. When the ball valves are in the operating position, contaminated water passes through the plurality of filters where the contaminated water is cleaned to 99.999% 5 log of Bacteria, Protozoa and Cysts. Additionally, when the plurality of filters begin to fowl due to clogging, the clean water outlet can be closed and one of the ball valves turned to backflush. As described above, this sends clean water from the opposite manifold in a reverse flow through manifold turned to backflush and out of the backflush outlet. The process can be reversed for cleaning the filters of the opposite manifold. After the manifolds have been cleaned, the ball valves can be turned to an operating position for cleaning more water. In some embodiments, the filter is constructed from ¾ schedule 40 PVC pipe and fittings. However, the filter is able to be constructed from any appropriately desired material.

The invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications area able to be made in the embodiment chosen for illustration without departing from the spirit and scope of the invention. Specifically, it will be apparent that the design of the irrigation system is able to be implemented in many different styles and configurations. Further, it will be apparent to one of ordinary skill in the art that the precise structure of the device is able to be substantially varied to accommodate various styles of water sources. Consequently, the claims should be broadly construed, consistent with the spirit and scope of the invention, and should not be limited to their exact, literal meaning.

We claim:

1. A water filter comprising:
a. a water inlet configured to couple with a water source outlet;
b. a first filter cartridge coupled to the water source outlet;
c. a second filter cartridge configured parallel to the first filter cartridge and coupled to the water source outlet; and
d. a clean water outlet coupled to the first filter cartridge and the second filter cartridge and configured to output clean water.

2. The water filter of claim 1, comprising a backflush drain coupled to the first filter cartridge and the second filter cartridge.

3. The water filter of claim 2, wherein the first filter cartridge and the second filter cartridge are separately backflushed.

4. The water filter of claim 1, comprising a first ball valve coupled to the first filter cartridge and a second ball valve coupled to the second filter cartridge.

5. The water filter of claim 4, wherein the first ball valve controls the water flow through the first filter cartridge and the second ball valve controls water flow through the second filter cartridge.

6. The water filter of claim 5, wherein the first filter and the second filter comprise hollow fiber membrane filter cartridges.

7. The water filter of claim 5, wherein the first filter and the second filter comprise 0.05 micron hollow fiber membrane filter cartridges.

8. The water filter of claim 1, wherein the water source outlet comprises one of a faucet, a sink, and a hose.

9. The water filter of claim 1, wherein the clean water outlet outputs drinking water.

10. A method of purifying water comprising:
a. coupling a water filter water source inlet with a contaminated water source outlet, wherein the water filter comprises a plurality of parallel manifolds;
b. activating the water source outlet to pass water through one or more filter cartridges of the parallel manifolds, and
c. outputting clean water from a clean water outlet of the water filter.

11. The method of claim 10, wherein the one or more filter cartridges comprise hollow fiber membrane filter cartridges.

12. The method of claim 11, wherein the one or more filter cartridges comprise 0.05 micron hollow fiber membrane filter cartridges.

13. The method of claim 10, wherein the water source outlet comprises one of a faucet, a sink, and a hose.

14. The method of claim 10, wherein the clean water outlet outputs drinking water.

15. The method of claim 10, comprising backflushing the water filter to clean the one or more filter cartridges.

16. The method of claim 15, wherein the parallel manifolds are separately backflushed.

17. A water filtering system comprising:
a. a water inlet configured to couple with a water source outlet;
b. a first manifold comprising a plurality of filter cartridges;
c. a second manifold parallel to the first manifold and comprising a plurality of filter cartridges; and
d. a clean water outlet coupled to the first manifold and the second manifold and configured to output clean drinking water.

18. The water filtering system of claim 17, wherein the first manifold and the second manifold each comprise three filter cartridges.

19. The water filtering system of claim 17, wherein the first manifold is controlled by a first ball valve and the second manifold is controlled by a second ball valve.

20. The water filtering system of claim 19, wherein the first ball valve and the second ball valve are turned to an operative position to allow water to pass through the first manifold and the second manifold.

21. The water filtering system of claim 19, wherein the first ball valve and the second ball valve are turned to a reverse position to backflush the first manifold and the second manifold.

22. The water filtering system of claim 21, wherein the first manifold and the second manifold are separately backflushed.
